(19) United States
(12) Patent Application Publication
(10) Pub. No.: US 2026/0027938 A1
(43) Pub. Date: Jan. 29, 2026

(54) Method and Apparatus for Authenticating a Vehicle at a Charging Station

(71) Applicant: Bayerische Motoren Werke Aktiengesellschaft, Muenchen (DE)

(72) Inventor: Alexander Busch, Planegg (DE)

(21) Appl. No.: 18/996,931

(22) PCT Filed: May 12, 2023
(86) PCT No.: PCT/EP2023/062706

§ 371 Date: Jan. 17, 2025

(30) Foreign Application Priority Data
Aug. 12, 2022 (DE) 10 2022 120 464.2

(51) Int. Cl. B60L 53/65; B60L 53/66

(52) U.S. Cl. CPC B60L 53/65; B60L 53/66; B60L 2240/62; B60L 2250/20

(57) ABSTRACT

A method for authenticating a vehicle at a charging station includes determining a position of the vehicle. The method also includes determining a contract certificate from a plurality of contract certificates of the vehicle depending on the position of the vehicle. The method further includes providing the contract certificate by the vehicle to the charging station, and authenticating the vehicle at the charging station with the provided contract certificate.

The present application is the U.S. national phase of PCT Application PCT/EP2023/062706 filed on May 12, 2023, which claims priority of German patent application No. 10 2022 120 464.2 filed on Aug. 12, 2022, the entire contents of which are incorporated herein by reference.

### TECHNICAL FIELD

The disclosure relates to the field of vehicles, and more particularly, authenticating a vehicle at a charging station.

### BACKGROUND

It is known from the prior art that multiple contract certificates are stored in a vehicle, which enable the vehicle to be charged at a charging station. A contract certificate must be manually selected by a user before charging at the charging station is possible.

There is a need to efficiently improve the authentication of a vehicle at a charging station. For example, there is a need to efficiently provide a contract certificate for authenticating the vehicle from the vehicle to the charging station.

### SUMMARY

The above-described needs, as well as others, are addressed by at least some embodiments disclosed herein.

A first aspect is a method for authenticating a vehicle at a charging station. The method can be a computer-implemented method and/or a control device-implemented method. The vehicle can be a motor vehicle, in particular a battery electric motor vehicle or a plug-in hybrid electric motor vehicle. The method includes determining a position of the vehicle. Furthermore, the method includes determining a contract certificate from a plurality of contract certificates of the vehicle depending on the position of the vehicle. The method provides the contract certificate through the vehicle to the charging station. Finally, the method involves authenticating the vehicle at the charging station with the contract certificate provided.

Advantageously, the method can efficiently determine a contract certificate with which the vehicle at the charging station is authenticated. By automatically determining a single contract certificate, the authentication of the vehicle at the charging station can be efficiently automated. The charging process at the charging station is efficiently simplified for the user of the vehicle. Manual determination of a contract certificate can be omitted for the user of the vehicle.

According to an advantageous design, the contract certificate can be a cryptographic contract certificate according to a plug-and-charge standard. For example, the contract certificate can be a contract certificate according to the ISO 15118 standard. The ISO 15118 standard standardizes a plug-and-charge function between a vehicle, especially an electric vehicle, and a charging station. The method can efficiently determine standardized contract certificates and thus efficiently simplify a standardized authentication of the vehicle at the charging station.

According to another advantageous design, the method may also include determining a user profile of the driver of the vehicle, and determining the contract certificate from the plurality of contract certificates of the vehicle depending on the position of the vehicle and the user profile of the driver of the vehicle. This allows a contract certificate to be efficiently determined by the vehicle.

According to another advantageous design, the user profile can include a first, user-specific preference value with regard to a feature of a contract certificate, and the contract certificate can be determined by means of the first, user-specific preference value of the user profile with regard to the feature of the contract certificate. This allows the contract certificate to be determined efficiently.

According to another advantageous design, the method can also include determining a user-specific charging profile of the vehicle, and determining the contract certificate from the plurality of contract certificates of the vehicle depending on the position of the vehicle, the user profile of the driver of the vehicle, and the user-specific charging profile of the vehicle. This allows the contract certificate to be determined efficiently.

According to another advantageous design, determining the contract certificate from a plurality of contract certificates of the vehicle depending on the position of the vehicle may include checking whether at least one contract certificate depending on the position of the vehicle has been determined depending on the position of the vehicle. If no contract certificate has been determined depending on the position of the vehicle, the method can load a new contract certificate from a vehicle-external server to the vehicle, wherein the new contract certificate is a contract certificate with which the vehicle at the charging station can be authenticated. Furthermore, the method can store the new contract certificate on the vehicle, and can designate the new contract certificate as the contract certificate for authenticating the vehicle at the charging station. This allows a contract certificate to be dynamically designated for the authentication of the vehicle at the charging station.

According to another advantageous design, determining the contract certificate from a plurality of contract certificates of the vehicle depending on the position of the vehicle can include determining a user-specific filter parameter and/or a vehicle-specific filter parameter, filtering the contract certificates from the plurality of contract certificates with the user-specific filter parameter and/or the vehicle-specific filter parameter to determine a single contract certificate from the plurality of contract certificates, and designating the single contract certificate as the contract certificate if more than one contract certificate has been determined from the plurality of contract certificates depending on the position of the vehicle. With this it can be efficiently ensured that a single contract certificate is designated for authenticating the vehicle at the charging station.

Another aspect is characterized by a computer-readable medium for authenticating a vehicle at a charging station, wherein the computer-readable medium contains instructions that, when executed on a computer or a control unit, carry out the method described above.

Another aspect is a system for authenticating a vehicle at a charging station, wherein the system is designed to carry out the method described above.

Yet another aspect is characterized by a vehicle containing the system described above for authenticating a vehicle at a charging station.

Further features result from the claims, the figure and the description of the figure. All the features and combinations of features mentioned above in the description as well as the features and combinations of features mentioned below in the description of the figure and/or shown in the figure alone can be used not only in the respective specified combination, but also in other combinations or on their own.

The above-described features and advantages, as well as others, will become more readily apparent to those of ordinary skill in the art by reference to the following detailed description and accompanying drawings.

### BRIEF DESCRIPTION OF THE DRAWING

FIG. 1 shows an exemplary method for authenticating a vehicle at a charging station.

### DETAILED DESCRIPTION

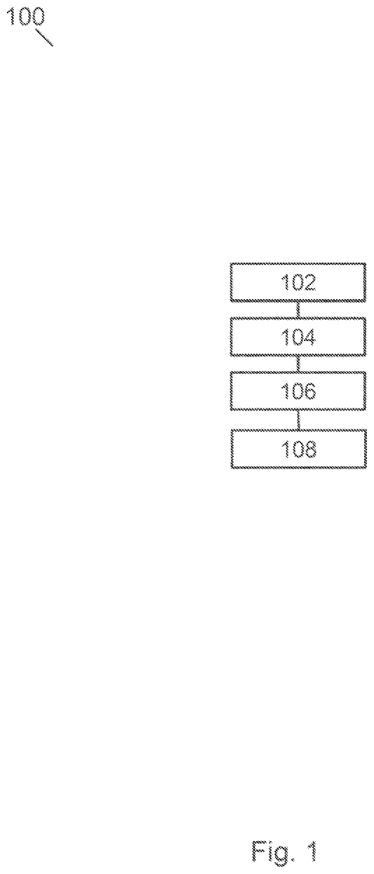

In detail, FIG. 1 shows an exemplary method 100 for authenticating a vehicle at a charging station. A plurality of contract certificates can be stored on a vehicle, with which the vehicle can authenticate itself at the charging station. For example, the plurality of contract certificates can include 1, 2, 3, 4, . . . , 10, 11, . . . , 20 contract certificates. For the authentication of the vehicle, it is necessary to determine exactly one contract certificate from the plurality of contract certificates with which the vehicle authenticates itself at the charging stations before a charging process. The method 100 enables the automated determination from the plurality of contract certificates of exactly one contract certificate that the vehicle uses for authentication of the vehicle at the charging station.

The method 100 can determine 102 a position of the vehicle. The position of the vehicle can be a parking position of the vehicle at the charging station. For example, the parking position of the vehicle can be a parking position on private property. For example, the parking position of the vehicle may be in a publicly accessible parking area. For example, the parking position of the vehicle can be in a public or non-public parking garage. The position of the vehicle can be a current position of the vehicle during a trip to the charging station. For example, the position of the vehicle can be determined if the vehicle is closer to a position of the charging station than a predetermined distance.

The method 100 can determine 104 a contract certificate from a plurality of contract certificates of the vehicle depending on the position of the vehicle. For example, a contract certificate may be associated with a location. If the position of the vehicle is at the location or in a close vicinity of the location, the method can determine a contract certificate from the plurality of contract certificates for which the position of the vehicle and the location associated with the contract certificate coincide.

The method 100 can additionally determine a user profile of a driver of the vehicle and the contract certificate from the plurality of contract certificates of the vehicle depending on the position of the vehicle and the user profile of the driver of the vehicle. The user profile of the driver of the vehicle is preferably stored on the vehicle. The user profile includes a first, user-specific preference value with regard to a feature of a contract certificate. The contract certificate can be determined by means of the first, user-specific preference value of the user profile with regard to the feature of the contract certificate. The first, user-specific preference value can specify user-specific prioritization of one or more contract certificates. For example, the user-specific prioritization can set a prioritization value for each contract certificate and/or for each feature of a contract certificate. The prioritization value can vary depending on location. The method can designate the contract certificate with the highest, location-based prioritization value from the plurality of contract certificates as the contract certificate with which the vehicle authenticates itself at the charging station. The user profile may include other user-specific preferences. For example, the user profile may include one or more rules that specify one or more user-specific preferences regarding the contract certificates stored in the vehicle. The method can implement one or more rules to determine a contract certificate from the plurality of contract certificates.

The method 100 can also determine a user-specific charging profile of the vehicle. The user-specific charging profile of the vehicle can be determined on a location basis depending on the position of the vehicle. In addition or alternatively, the user-specific charging profile of the vehicle can be determined on a time basis.

The method can determine the contract certificate from the plurality of contract certificates of the vehicle depending on the position of the vehicle, the user profile of the driver of the vehicle, and the user-specific charging profile of the vehicle. The user-specific charging profile can include location-based settings for configurable charging parameters such as maximum AC charging current, maximum DC charging current, and/or charging times. In addition or alternatively, the method can use the location-based settings for configurable charging parameters for location-based determination of the contract certificate from the plurality of contract certificates with which the vehicle authenticates itself at the charging station.

In the event that none of the contract certificates stored on the vehicle is suitable for authenticating the vehicle at the charging station, i.e. no contract certificate could be determined depending on the position of the vehicle, no contract certificate corresponds to one or more preference values of the driver's user profile and/or no contract certificate meets the user-specific charging settings, the method can load a new contract certificate from a vehicle-external server onto the vehicle. The new contract certificate is preferably a contract certificate with which the vehicle at the charging station can be authenticated. In addition, the new contract certificate can meet one or more preference values of the driver's user profile and/or the user-specific charging settings. The new contract certificate can be stored on the vehicle, and can be designated as the contract certificate for authenticating the vehicle at the charging station.

In the event that multiple contract certificates stored on the vehicle are suitable for authenticating the vehicle at the charging station depending on the position of the vehicle, the vehicle may determine one or more user-specific filter parameters and/or one or more vehicle-specific filter parameters as described above in order to filter the multiple contract certificates stored on the vehicle. For example, one or more preference values of the driver's user profile and/or one or more charging parameters of the charging profile can be used as user-specific and/or vehicle-specific filter parameters. The filter parameters can be applied sequentially to determine a single contract certificate as the contract certificate with which the vehicle is authenticated at the charging station. If filtering with the above filter parameters results in more than one contract certificate still being available to authenticate the vehicle, the method can provide the filtered contract certificates to a driver of the vehicle. For example, the filtered contract certificates can be displayed to the driver on a display when the vehicle is parked, for example on a good-bye screen of a vehicle display device. The driver can designate a contract certificate of the filtered contract certificates, which the vehicle authenticates itself at the charging station.

In addition or alternatively, the method can determine the contract certificate depending on a destination. For example, if the destination is a driver's place of work, a contract certificate linked to the driver's place of work can be determined. If, for example, the driver's vehicle is a company car, a contract certificate can be determined that is linked to a company car vehicle type. In addition or alternatively, the destination and the vehicle type can be combined to determine the contract certificate. If the destination is the place of work and the vehicle type is a company car, a contract certificate can be determined with which the vehicle can be authenticated as a company car at the place of work.

The method 100 may include providing 106 the designated contract certificate through the vehicle to the charging station. The provision 106, for example, may include transmission of the contract certificate via a wireless communication interface from the vehicle to the charging station. Finally, the method 100 may include authenticating 108 the vehicle at the charging station with the contract certificate provided. Authentication 108 of the vehicle at the charging station with the contract certificate can be automated. For example, the vehicle can be automatically authenticated at the charging station with the contract certificate according to the ISO 15118 standard, often also known as the plug-and-charge standard.

Advantageously, the method can efficiently determine a single contract certificate automatically and thus authenticate the vehicle automatically at the charging station.

### LIST OF REFERENCE SIGNS

100 Method
102 Determining a position
104 Determining a contract certificate
106 Providing the contract certificate
108 Authenticating a vehicle at a charging station

1-10. (canceled)

11. A method for authenticating a vehicle at a charging station:
determining a position of the vehicle;
determining a contract certificate from a plurality of contract certificates of the vehicle depending on the position of the vehicle;
providing the contract certificate by the vehicle to the charging station; and
authenticating the vehicle at the charging station with the provided contract certificate.

12. The method as claimed in claim 11, wherein the contract certificate is a cryptographic contract certificate according to a plug-and-charge standard.

13. The method as claimed in claim 11, wherein the plurality of contract certificates are stored on the vehicle.

14. The method as claimed in claim 11, further comprising determining a user profile of a driver of the vehicle, and wherein determining the contract certificate further comprises determining the contract certificate from the plurality of contract certificates of the vehicle depending on the position of the vehicle and the user profile of the driver of the vehicle.

15. The method as claimed in claim 14, wherein the user profile includes a first, user-specific preference value with respect to a feature of a contract certificate; and
wherein the contract certificate is determined at least in part using the first, user-specific preference value of the user profile with regard to the feature of the contract certificate.

16. The method as claimed in claim 15, further comprising:
determining a user-specific charging profile of the vehicle, and wherein determining the contract certificate further comprises determining the contract certificate from the plurality of contract certificates of the vehicle depending on the position of the vehicle, the user profile of the driver of the vehicle, and the user-specific charging profile of the vehicle.

17. The method as claimed in claim 16, wherein the user profile is stored on the vehicle.

18. The method as claimed in claim 16, wherein the contract certificate is a cryptographic contract certificate according to a plug-and-charge standard.

19. The method as claimed in claim 11, further comprising:
determining a user-specific charging profile of the vehicle, and wherein determining the contract certificate further comprises determining the contract certificate from the plurality of contract certificates of the vehicle depending on the position of the vehicle, and the user-specific charging profile of the vehicle.

20. The method as claimed in claim 11, wherein the contract certificate is a cryptographic contract certificate according to a plug-and-charge standard.

21. The method as claimed in claim 11, wherein determining the contract certificate from a plurality of contract certificates of the vehicle depending on the position of the vehicle includes:
checking whether at least one contract certificate depending on the position of the vehicle has been determined depending on the position of the vehicle from an existing plurality of contract certificates of the vehicle;
if no contract certificate has been determined depending on the position of the vehicle:
loading a new contract certificate from a vehicle-external server to the vehicle, wherein the new contract certificate is a contract certificate that can be used to authenticate the vehicle at the charging station;
storing the new contract certificate on the vehicle, wherein the plurality of contract certificates of the vehicle includes the new contract certificate and the existing plurality of contract certificates of the vehicle; and
designating the new contract certificate as the contract certificate for authenticating the vehicle at the charging station.

22. The method as claimed in claim 11, wherein determining the contract certificate from a plurality of contract certificates of the vehicle depending on the position of the vehicle further includes:
identifying more than one contract certificate from the plurality of contract certificates depending on the position of the vehicle:
determining a user-specific filter parameter;
filtering the contract certificate from the plurality of contract certificates using the user-specific filter parameter to determine a single contract certificate from the plurality of contract certificates; and
designating the single contract certificate as the contract certificate.

23. The method as claimed in claim 11, wherein determining the contract certificate from a plurality of contract certificates of the vehicle depending on the position of the vehicle further includes:
identifying more than one contract certificate from the plurality of contract certificates depending on the position of the vehicle:
determining a user-specific filter parameter and a vehicle-specific filter parameter;
filtering the contract certificate from the plurality of contract certificates using the user-specific filter parameter and the vehicle-specific filter parameter to determine a single contract certificate from the plurality of contract certificates; and
designating the single contract certificate as the contract certificate.

24. The method as claimed in claim 23, wherein the contract certificate is a cryptographic contract certificate according to a plug-and-charge standard.

25. The method as claimed in claim 11, wherein determining the contract certificate from a plurality of contract certificates of the vehicle depending on the position of the vehicle further includes:
Identifying more than one contract certificate from the plurality of contract certificates depending on the position of the vehicle:
determining a vehicle-specific filter parameter;
filtering the contract certificate from the plurality of contract certificates using the vehicle-specific filter parameter to determine a single contract certificate from the plurality of contract certificates; and
designating the single contract certificate as the contract certificate.

26. A non-transitory computer-readable medium for authenticating a vehicle at a charging station, wherein the computer-readable medium contains instructions which, when executed on a computer or a control unit, carry out the method as claimed in claim 11.

27. A system for authenticating a vehicle at a charging station, wherein the system is designed to carry out the method as claimed in claim 11.

28. A vehicle containing the system for authenticating a vehicle at a charging station as claimed in claim 27.
